(19) United States
(12) Patent Application Publication
(10) Pub. No.: US 2018/0139929 A1
(43) Pub. Date: May 24, 2018

(54) Body Temperature Modulating Garment

(71) Applicant: David Hill, Denver, CO (US)

(72) Inventor: David Hill, Denver, CO (US)

(21) Appl. No.: 15/360,634

(22) Filed: Nov. 23, 2016

(51) Int. Cl. A01K 13/00

(52) U.S. Cl. CPC A01K 13/006; A01K 13/008

(57) ABSTRACT

A garment for facilitating the effective body temperature modulation, e.g., cooling, that incorporates both evaporative and radiant cooling phenomena is described. The present invention generally relates to a garment and method of use thereof for body temperature modulation of companion animals, specifically, a garment incorporates evaporative cooling, radiant cooling, or the combination thereof, which is configured to carry, e.g., ice in compartments that allow the melting ice to bathe the animal's skin directly in cool water, thereby facilitating evaporative and radiant cooling simultaneously, while adding only minimal weight to the animal's load. The garment comprises: a bodice, at least belt member having at least one adjustable fastening means, and at least one compartment for receiving a cooling and/or heating agent.

### FIELD OF INVENTION

The present invention relates generally to garments, and specifically garments intended to be used to modulate the body temperature of mammals, in particular companion animals. More specifically, the present invention relates to a garment for modulating, for example, cooling, the body temperature of a companion animal, and methods of use thereof.

### BACKGROUND OF INVENTION

Currently, there are no sufficiently effective lightweight and breathable garments for companion animals that effectively modulate, i.e., increase or decrease, body temperature that are useful in multiple settings, e.g., during exercise, before and/or after surgery, as a therapeutic treatment, at rest. The group known as companion animals generally includes cats, dogs, and horses, and more recently, miniature and potbelly pigs. For purposes of clarity, the discussion herein is directed to dogs, but those skilled in the art will readily recognize that all and alternative embodiments of the present invention may be adapted to other mammals, including humans, companion, and non-companion animals.

Dogs are just one example of an animal having a limited ability to reduce its body temperature. Dogs reduce their body temperature via panting and through their paws, both of which are not as effective as the mechanism of sweating and evaporative cooling used by others. Consequently, dogs have a tendency to overheat during exercise, especially in warm weather or with direct exposure to sunlight. Known methods for lowering body temperature include evaporative and/or radiant cooling. The former may be achieved by wetting the animal with or without a blanket, while the latter may be achieved by physically placing chilled objects in contact with the dog's body. In addition to cooling an animal, increasing body temperature may be achieved in similar manners by retaining body heat with a cover or physically placing warmed objects in contact with the dog's body. One of the disadvantages with these methods is that the same objects, e.g., blankets, heating pads, ice pack, warm packs, are cumbersome and not useful in all cases of body temperature modulation. Another disadvantage is that covers tend to hold in body heat preventing true evaporative cooling.

Known devices and methods in this field include, for example, garments made of reflective materials and garments configured for carrying cooling packs. Reflective materials deflect the heat from, e.g., sunlight, away from the animal but do not address the issue of body temperature increase from, e.g., exercise or fever. Garments configured to carry cooling, or warming, packs continue to carry those packs after their utility is exhausted, thereby placing extra weight and stress on the dog, and continuing to trap heat. Alternatives have described the use of high absorbency fabrics soaked in, e.g., cold liquids for cooling purposes, however, after the fabric's utility has been exhausted, the animal is left wearing a wet, heavy garment that may further insulate the dog.

Although companion animal garments are widely available and used for aesthetics, warmth in cool weather, and sometimes cool down, an alternative simpler and more efficient way of modulating body temperature has not been suggested in the prior art. The development of a garment that effectively and efficiently modulates an animal's body temperature would be a valuable tool for first responders, search and rescue (working) animals, exercise buddies, and veterinarians.

There is an unmet need for a light-weight and breathable garment that effectively modulates an animal's body temperature through evaporative cooling, radiant cooling, or the combination thereof, while adding minimal weight load to the animal. A body temperature modulating garment may function to absorb body heat from and provide evaporative cooling to the torso of an animal—where the critical heart and lungs are located—to help reduce core body temperature, and in turn, may reduce the likelihood of heat stress or stroke. By using ice as a cooling agent, the direct contact with the animal begins the cooling process which is continued by the evaporation of the melted ice from the body of the dog. The present invention includes a novel garment and method of use thereof for use in the body temperature modulation of companion animals.

The present invention generally relates to a garment and method of use thereof for body temperature modulation of companion animals, specifically, a garment that incorporates evaporative cooling, radiant cooling, or the combination thereof, which is configured to carry, e.g., ice in compartments that allow the melting ice to contact and bathe the animal's coat directly in cool water, thereby facilitating evaporative and radiant cooling simultaneously, while adding only minimal weight to the animal's load. That is, as the ice melts, the cold water further cools the animal's core temperature, and then the water is evaporated off the animal, the minimal weight of the garment itself is the only addition to the load carried by the dog.

### SUMMARY OF INVENTION

The present invention overcomes the existing drawbacks and prior art by providing a garment that is made up of lightweight and breathable fabric, and configured with at least one or a plurality of compartments disposed thereon for accepting temperature modulating agents, and thereby provides an efficient and simple manner for modulating the body temperature of a companion animal. The invention is based on a novel concept for effecting body temperature modulation, for example, cooling.

Broadly, the present invention contemplates a garment for the body temperature modulation for a companion animal, comprising: a lightweight and breathable fabric, wherein said fabric is configured to comprise a bodice; at least one compartment disposed on the garment, wherein said compartment is configured to receive a heating or cooling agent; and, at least one belt member having an adjustable fastening means for removably securing the garment on the companion animal. In some embodiments, the bodice may be configured in a generally oval shape. In some embodiments, the garment may be constructed of a unitary body/piece of fabric or of integrally combined components of fabric, upon which at least one compartment and at least one fastening means are mounted. In some embodiments, the garment may have an edge binding, may have rolled edges, or may have unfinished edges.

In some embodiments of the garment, the present invention comprises: a unitary bodice configured in a generally oval shape with a cut out portion at the anterior end of the bodice creating a neck cradle and fastening arms. Longitudinally disposed and approximately and symmetrically centered is at least one, and preferably a plurality of compartments. Disposed laterally to the compartments is at least a pair of attachment belts with a fastening means integrally incorporated thereon for securing the garment on the animal.

In some embodiments of the present invention, the unitary bodice is configured to have a circular cut out portion creating an aperture there through for pulling over an animal's head.

In some of the embodiments, a plurality of strategically placed attachment belts extend laterally from the bodice.

The presently described garment is particularly useful for lowering companion animal body temperature, but may be used or adapted for any number of alternative uses. When practiced as disclosed herein, the present invention provides a single garment useful for the efficient and effective body temperature modulation of a companion animal. The present invention, thus, is useful as disclosed herein, but is not intended to be limited to these uses.

It is an object of the present invention to provide an easy to use garment for efficiently and effectively cooling and/or warming a companion animal. It is another object of the present invention to provide a garment that is relatively simple structurally, and thus, simple to manufacture.

Broadly, embodiments of the present invention comprise the same general elements: a bodice, at least one attachment belt with an adjustable fastening means, and at least one compartment disposed on the bodice. The present invention may further include a tail loop for stabilization, additional belts, storage compartments, hood attachments, or aesthetic components. These and other objects and advantages of the present invention will be apparent from the drawings, the detailed description, and the appended claims. The above listing of objects of the invention should not be deemed as all-inclusive in any manner whatsoever.

### DESCRIPTION OF FIGURES

Illustrative and exemplary embodiments of the invention are shown in the drawings in which:

FIG. 1 shows a top perspective view of an embodiment of the garment of the present invention. The garment is viewed from the top as laid out flat, exposing the entire outer surface of the garment;

FIG. 2 shows a side perspective view of an embodiment of the garment of the present invention. In this embodiment, when folded longitudinally down the center of the garment, each of the halves is symmetrical.\

FIG. 3 is a left, side perspective view of an embodiment of the garment in use.

FIG. 4 is a top perspective view of an embodiment of the garment in use.

FIG. 5 is a front perspective view of an embodiment of the garment in use.

FIGS. 6a shows an alternative embodiment of the garment, comprising pull over format.

FIGS. 6b shows an alternative embodiment of the garment, comprising pull over format further comprising leg apertures.

FIGS. 6c shows an alternative embodiment of the garment, comprising a non-pull over format further comprising leg apertures.

FIGS. 6d shows an alternative embodiment of the garment, comprising a harness configuration of the garment.

FIGS. 6e shows an alternative embodiment of the garment, comprising a single extended length belt member.

FIGS. 6f shows an alternative embodiment of the garment, comprising a body wrap format.

Elements and facts in the figures are illustrated for simplicity and have not necessarily been rendered according to any particular sequence or embodiment.

### DETAILED DESCRIPTION OF THE INVENTION

The embodiments of the present invention described below are not intended to be exhaustive or to limit the invention to the precise forms disclosed in the following detailed description. Rather, the embodiments are chosen and described so that others skilled in the art can appreciate and understand the principles and practices of the present invention.

Aspects and applications of the invention presented here are described in the drawings and detailed description of the invention. Unless specifically noted, it is intended that the words and phrases in the specification and the claims be given their plain ordinary and accustomed meaning to those of ordinary skill in the applicable arts. Accordingly, various implementations may be very broadly adopted and applicable.

The evaporation process occurs when moisture is absorbed into the atmosphere, requiring sufficient heat to convert the moisture into vapor. An example of this process is the evaporation of sweat from the skin of a mammal. When the ambient temperature is high enough that the animal's body temperature begins to rise above normal, an autonomic mechanism—sweating—begins. That is, as body temperature increases, sweat is produced, the combination thereof is sufficient to evaporate the sweat into the air, cooling the body surface. Not all mammals sweat. Therefore, wetting the surface of a non-sweating mammal is a way to replicate evaporative cooling, reducing the body surface temperature, and in turn, reducing the body temperature of the animal. Ice may be used in this replication by placing it against the body surface. The body contact with the ice conducts some heat away from the animal, and as the ice melts the water allows for additional cooling, and wets the skin of the animal providing moisture to feed the evaporative cooling process.

The present invention generally relates to a garment and method of use thereof for body temperature modulation of companion animals, specifically, the garment incorporates evaporative cooling, radiant cooling, or the combination thereof. The garment is configured to carry a cooling agent, e.g., ice, in compartments that allow the melting ice to bath the animal's skin directly in cool water, thereby facilitating evaporative and radiant cooling simultaneously. The addition of ice to the garment compartments initially adds some weight to the animal's carry load, but as the ice melts and the water evaporates, only the minimal weight of the light weight garment is added to the animal's load. Furthermore, the breathability of the garment continues to allow the animal to remain cool while wearing the garment. Alternatively, for warming purposes, the lightweight and breathability of the garment provide a means for allowing excess heat to escape, and thus, during a warming process the animal does not inadvertently overheat.

The term “garment” as used herein, generically includes any animal covering. That is, those skilled in the art would specifically call by the name garment, or by any at least partly analogous term such as blanket, cover, vest, sheet, robe, sweater, jacket, or the like. Certainly, one skilled in the art is aware that the present invention is also applicable to conventional garment production and not limited to companion animal garments.

The garment may be shaped and sized to accommodate a plethora of animal sizes, e.g. teacup, miniature, standard, giant, etc. Based on the size and shape of the garment, each of the components comprising the garment are adapted to well suit the intended user. The garment is comprised of a bodice, at least one attachment belt having an adjustable fastening means, and at least one compartment disposed on said bodice. The bodice is preferably constructed of what is generally referred to as “hex” mesh, but may be constructed of any number of light-weight, breathable, materials, e.g., synthetic polyester yarn, ripstop nylon, perforated spandex, halas lace, linen, microfiber, seersucker cotton. In some embodiments, the range of the apertures in the mesh range from about 1 mm to 30 mm, preferably from about 2 mm to 10 mm, and in some most preferable embodiments, approximately a 4 mm nylon hex mesh may be employed for construction. The term “mesh” as used herein is a basic barrier or fabric made of connected strands of fiber, or other flexible and/or ductile materials. Visually, mesh is similar to a web or a net, a.k.a., webbed fabric or netting, in that it has multiple strands of fiber that are attached, intertwined, and/or woven in relation to one another creating an open weave appearance and functionality of the fabric. Preferably, the mesh, or netting or web-type fabrics that offer a light weight and breathability aspect for the present invention is constructed of either of nylon or polyester fiber to facilitate quick and effective evaporation, but other fibers or materials could be alternatively used.

The term “compartment” as used herein, generically includes any pocket-like structure disposed on the outer surface of the bodice of the garment and forming a pouch used for and capable of having an article inserted therein, including at least partly analogous terms such as bag, pouch, pocket, capsule, cell, chamber, or the like. In some embodiments, the compartment is a single fabric piece disposed on the bodice, whereby there is no “back” to the pocket and any compartment contents are in direct contact with the bodice construction material, i.e., mesh, and dog's body surface. Alternative embodiments of compartments may have a back, a backing, may be constructed of insulating material to extend the life of the temperature modulating agent, or may be removably and adjustably mounted on the bodice of the garment for strategic placement. The use of ice as a temperature modulating, e.g., cooling, agent exposed directly to the dog's skin, allows for melting and in turn, evaporation of the resulting water, thereby providing both cooling and weight reduction of the garment. Once the ice melts and the water evaporates, the animal is left wearing only a light-weight mesh garment that is breathable and does not trap heat.

The term “temperature modulating agent” as used herein includes any material capable of being used to modulate the body temperature of the animal, e.g., ice, ice packs, instant cooling materials, warm/cold gels, heat pack, disposable chemical warming packets (HotHands™), and the like,.

The general idea of an animal garment is known to those skilled in the art. The present invention adds to the concept and overcome(s) the shortcomings of the prior art.

According to one embodiment, the invention is directed to a garment configured to drape over the back of animal, for example, a dog, and be secured thereon. In one embodiment, there is a mesh bodice having a generally oval shape and an accommodation for the animal's head and neck/chest, at least one belt member with an adjustable fastening means for securing the garment to the animal, and at least one compartment disposed on the outer surface of the bodice, such that the compartment holds a temperature modulating agent against the garment and the dog's body surface when engaged. In use, some embodiments of the garment are placed over the top of a standing dog, securely fastening the fabric arms extending from the anterior end of the garment about the dog's neck and/or chest, and then fastening and adjusting at least one attachment belt underneath the torso of the dog.

The invention may be used either alone or in combination with other garments. One skilled in the art will readily recognize that the disclosed garment and methods of the present invention can be readily incorporated into one of the established formats for companion animal garments and the like that are well known in the art.

Broadly, the present invention is comprised of a unitary bodice, preferably constructed of mesh textile fabric, at least one attachment belt, and at least one compartment. Alternatively, the bodice may be constructed of a plurality of fabric pieces providing a complete garment when pieced together. The bodice may further comprise a no-slip fabric edging to stabilize the garment in use. The garment of the present invention offers significant advantages over the prior art, including but not limited to: light-weight breathable material construction in combination with little additional weight load to the dog while cooling the body temperature.

Each of the member components of the present invention may be constructed of any number of materials. The choice of materials utilized for construction may be based upon, for example, aesthetics, weight, strength, flexibility, intended use, cost, ease of manufacturing, or other desirable attributes. Examples of materials include, but are not limited to, those recited herein, and combinations thereof, or the like. The bodice may be constructed in any shape, for example, having a general shape of square, rectangle, triangle, oval, circle, provided the chosen shape does not negatively alter the functionality of the garment. In broad terms, a bodice is a symmetrical shape, having an upper and lower surface, wherein the lower surface is intended, in use, to be in direct contact with the dog's body. The functionality of the bodice is to secure the cooling agents in place without weighing down the animal or trapping its body heat while in use. Alternative embodiments include over-the-head bodice configuration, harness, or front leg step-in bodice configuration. The garment further comprises at least one belt member, said belt member being either centrally mounted or offset on the bodice, provided the belt placement does not impair the balance and functionality of the garment as a whole, and an adjustable fastening means. As used herein, “fastening means” may comprise, e.g., a hook-and-loop, button, clasp, buckle, hook, clip, or the like. At least one compartment, and preferably at least two compartments, for carrying a temperature modulating agent is disposed on the upper surface of the bodice. Compartments may be constructed from a multitude of textiles, e.g., sheer vinyl, plastic coated vinyl, insulated vinyl, polyester, nylon, or the like.

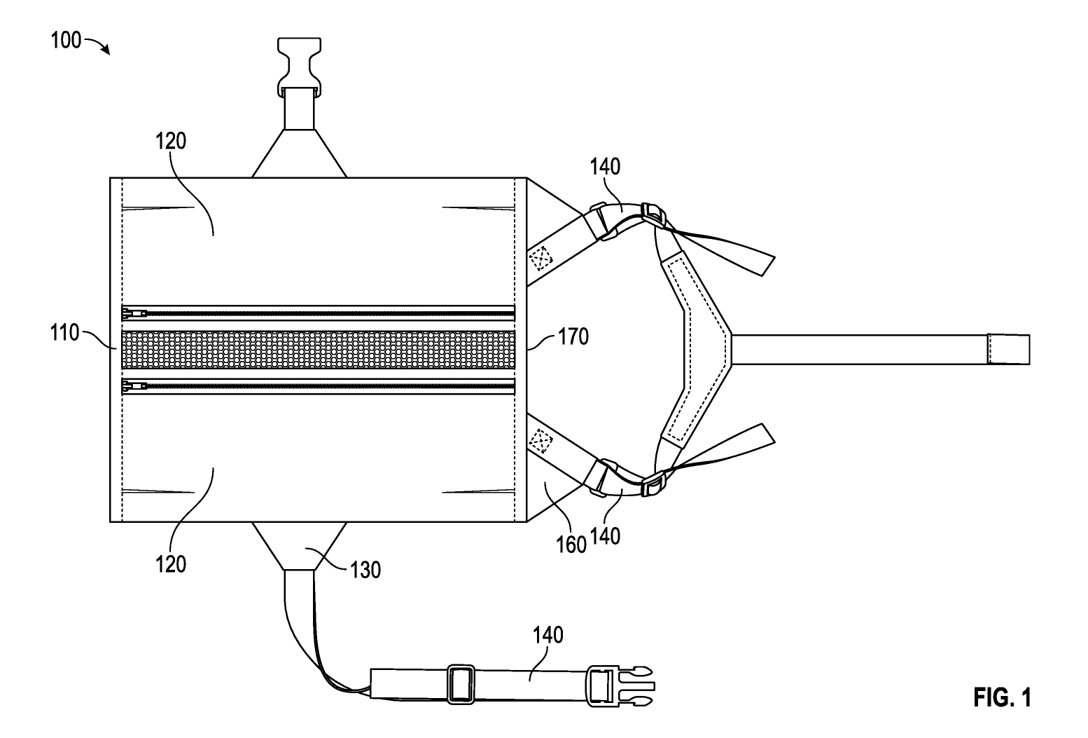

Referring now to FIG. 1, there is illustrated an embodiment of the garment of the present invention, generally indicated by the reference numeral 100, showing an embodiment of the bodice 110, compartments 120 for receiving the temperature modulating agent, belt members 130 having adjustable fastening means 140 and arms 160 having adjustable fastening means 140 for securing the garment to the animal, and neck cradle 170, functionally assembled into a garment of the present invention.

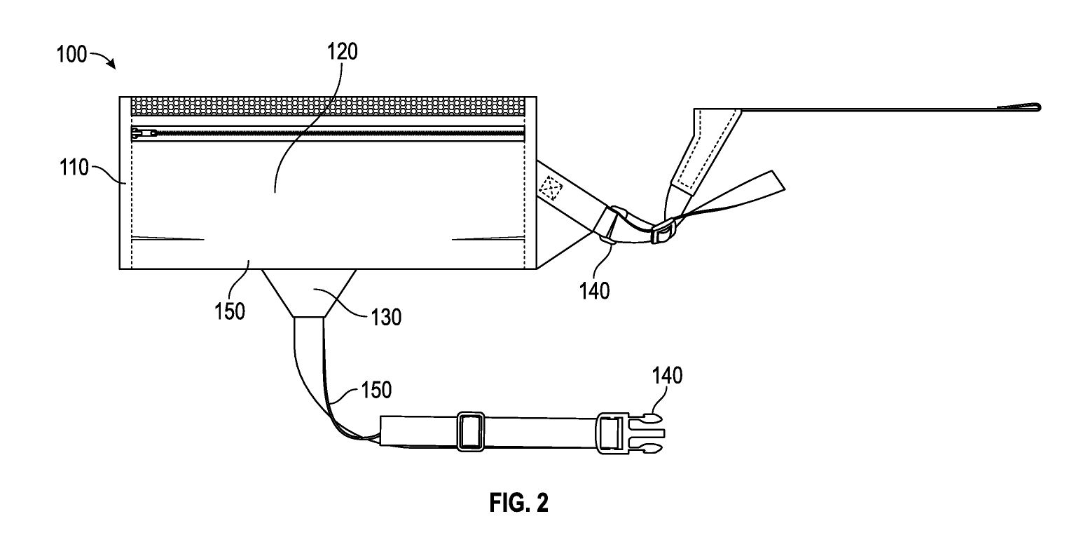

Moving to FIG. 2, there is illustrated a side view of the garment 100 showing a closer view of the compartment 120. A compartment and/or compartments are strategically placed on the bodice 110 of the garment for the most effective position for cooling and/or heating. For example, the torso of an animal that does not sweat may be the warmest part of the animal's body because respiration is their primary source of cooling. In order to efficiently cool the animal, at least one compartment 120, and preferably at least one on each side of the animal, is disposed on the bodice 110 of the garment. In some embodiments, a plurality of compartments 120 may be disposed thereon, and alternatively, compartments may be disposed anywhere on the garment that does not interfere with the functionality thereof. The size and shape of the compartment or compartments 120 is configured based on the size and shape of the garment 100 which is, in turn, determined based on its intended use and the size and species of intended animal.

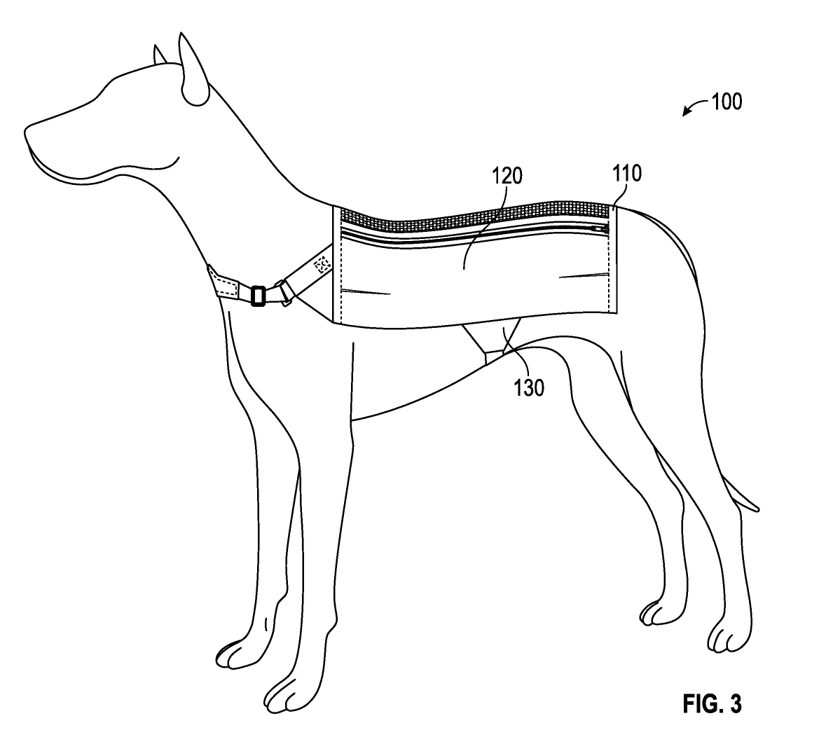

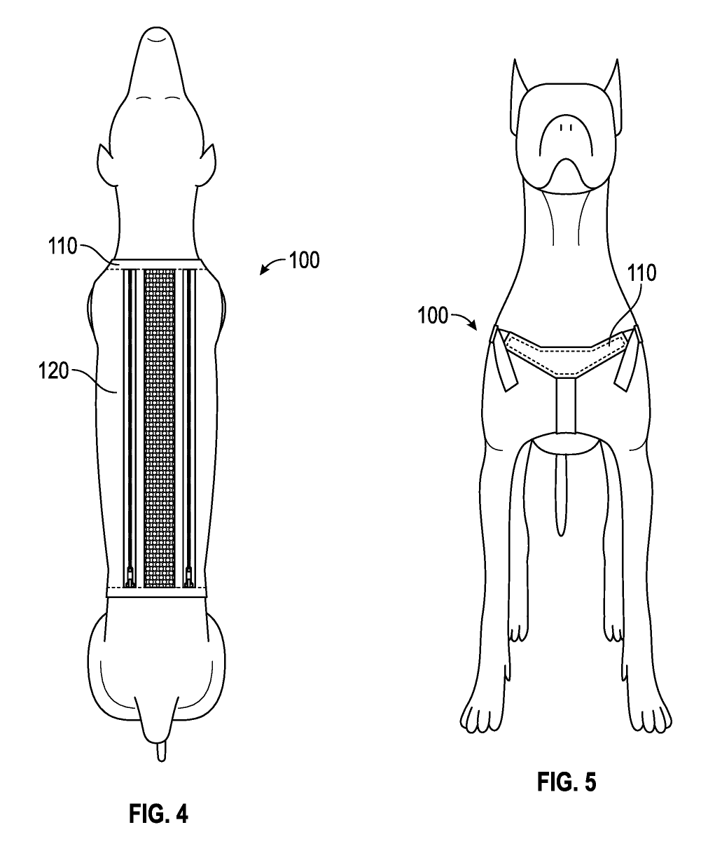

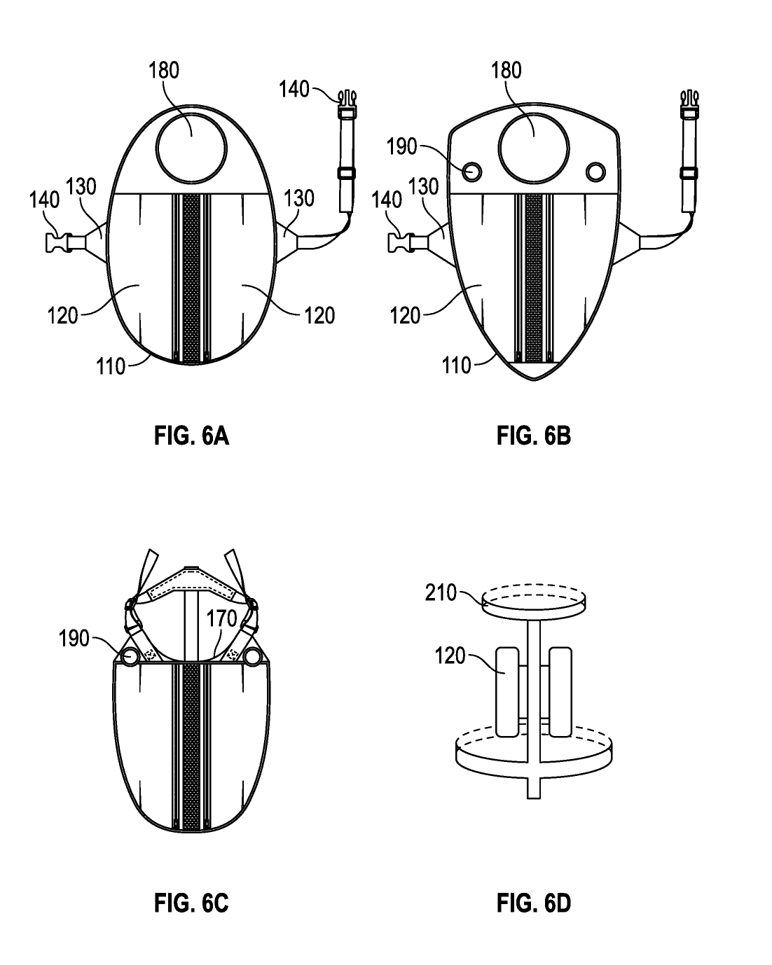

Moving now to FIGS. 3-5, the garment of the present invention is shown from the left side, top, and front perspectives, respectively, when engaged on a companion animal, i.e., dog.

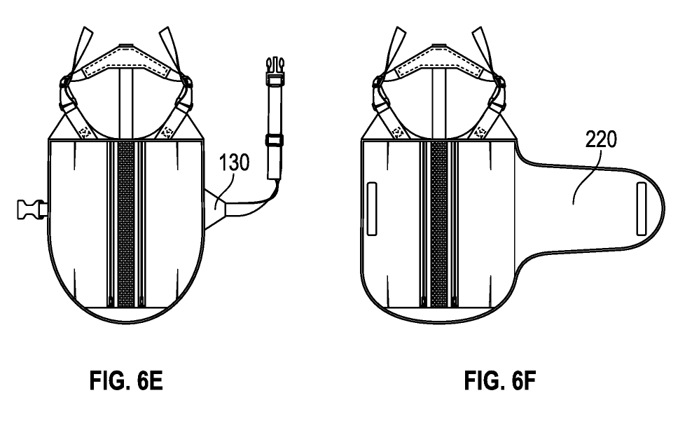

FIGS. 6a-f depict alternative embodiments, for example, in FIG. 6a, a head aperture 180 for insertion of the dog's head replaces the arms in other embodiments. In FIG. 6b, leg apertures 190 are further included in the embodiment. FIG. 6c depicts an embodiment with leg apertures 190. A compartment 120 for receiving temperature modulating agents in further included on the anterior section of the embodiment. FIG. 6d illustrates the use of a harness 210 alternative embodiment of the present inventions, while an embodiment comprising a plurality of belt members 130. In FIGS. 6e and 6f, a single extended length belt member 130 and a body wrap member 220 are depicted.

The animal cooling vest is shaped and sized to the shoulders, chest, and torso of the animal for which it is intended, and is attached by means of at least one static or adjustable belt member 130 with an adjustable fastening means 140 disposed thereon. The size and arrangement of belt members utilized to secure the vest is dependent upon its intended use as well as the size of and species of the intended animal because the garment is intended for use on either a motionless or a moving animal. The configuration is intended to be secure without hindering the animal's full range of motion or interfering with the resting comfort.

The present invention may be construction from varying thicknesses or constructions of the mesh as disclosed herein. For example, to reduce direct body contact with ice, thereby prevent potential skin shock or burn, a thicker mesh may be employed. Alternatively, for more breathability a mesh having larger apertures may be chosen for construction. Further, an optional mesh or other fabric insert may be inserted into one or more of the compartments to add space or separation between the temperature modulating agent and the skin of the animal.

One skilled in the art could make any number of embodiments and/or adjustments to the garment of the present invention based on elements such as, size, construction material, weight, etc., without undue experimentation. Having herein set forth various embodiment of the present invention, it is anticipated that suitable modification can be made thereto which will nonetheless remain within the scope of the invention.

What is claimed is:

1. A body temperature modulating garment for a companion animal comprising:
a lightweight and breathable fabric, wherein said fabric is configured to comprise a bodice;
at least one compartment disposed on the garment, wherein said compartment is configured to receive a heating or cooling agent; and,
at least one belt member having an adjustable fastening means for removably securing the garment on the companion animal.

2. A body temperature modulating garment for a companion animal comprising:
a lightweight and breathable fabric, wherein said fabric is configured to comprise a bodice, wherein said bodice has an upper and lower surface, and an anterior and posterior end;
at least one arm extending from the anterior end of the bodice, wherein said at least one arm further comprises an adjustable fastening means, and wherein said at least one arm defines a neck cradle;
at least one compartment disposed on the upper surface of the garment, wherein said compartment is configured to receive a heating or cooling agent; and,
at least one belt member having at least one adjustable fastening means for removably securing the garment on the companion animal.
